(19) United States
(12) Patent Application Publication
(10) Pub. No.: US 2010/0246683 A1
(43) Pub. Date: Sep. 30, 2010

(54) Error Resilience in Video Decoding

(76) Inventors: Jennifer Lois Harmon Webb, Dallas, TX (US); Wai-Ming Lai, Plano, TX (US)

Correspondence Address: TEXAS INSTRUMENTS INCORPORATED, P O BOX 655474, M/S 3999, DALLAS, TX, 75265, US

(21) Appl. No.: 12/413,265

(22) Filed: Mar. 27, 2009

(51) Int. Cl. H04N 7/26

(52) U.S. Cl. 375/240.16; 375/240.25; 375/E07.027; 375/E07.123

(57) ABSTRACT

A method for decoding an encoded video stream is provided that includes when a sequence parameter set in the encoded video stream is lost, wherein the sequence parameter set includes a frame number parameter, a picture order count parameter, a picture height parameter, a picture width parameter, and a plurality of non-critical parameters, assigning default values to the plurality of non-critical parameters, setting the picture height parameter and the picture width parameter based on a common pixel resolution, when a slice header of an instantaneous decoding refresh picture is available, determining the frame number parameter from the slice header, and determining the picture order count parameter using the frame number parameter, the default values, the pixel height parameter, and the picture width parameter, and using the parameters to decode a slice in the encoded video stream.

### BACKGROUND OF THE INVENTION

The demand for digital video products continues to increase. Some examples of applications for digital video include video communication, security and surveillance, industrial automation, and entertainment (e.g., DV, HDTV, satellite TV, set-top boxes, Internet video streaming, digital cameras, video jukeboxes, high-end displays and personal video recorders). In addition, new applications are in design or early deployment. Further, video applications are becoming increasingly mobile and converged as a result of higher computation power in handsets, advances in battery technology, and high-speed wireless connectivity.

Video compression is an essential enabler for video products. Compression-decompression (CODEC) algorithms enable storage and transmission of digital video. Typically codecs are industry standards such as MPEG-2, MPEG-4, H.264/AVC, etc. At the core of all of these standards is the hybrid video coding technique of block motion compensation (prediction) plus transform coding of prediction error. Block motion compensation is used to remove temporal redundancy between successive pictures (frames or fields) by prediction from prior pictures, whereas transform coding is used to remove spatial redundancy within each block.

Traditional block motion compensation schemes basically assume that between successive pictures an object in a scene undergoes a displacement in the x- and y-directions and these displacements define the components of a motion vector. Thus, an object in one picture can be predicted from the object in a prior picture by using the object's motion vector. Block motion compensation simply partitions a picture into blocks and treats each block as an object and then finds its motion vector using the most-similar block in a prior picture (motion estimation). This simple assumption works out in a satisfactory fashion in most cases in practice, and thus block motion compensation has become the most widely used technique for temporal redundancy removal in video coding standards. Further, periodically pictures coded without motion compensation are inserted to avoid error propagation; pictures encoded without motion compensation are called intra-coded (I-pictures), and blocks encoded with motion compensation are called inter-coded or predicted (P-pictures).

Block motion compensation methods typically decompose a picture into macroblocks where each macroblock contains four 8×8 luminance (Y) blocks plus two 8×8 chrominance (Cb and Cr or U and V) blocks, although other block sizes, such as 4×4, are also used in H.264/AVC. The residual (prediction error) block can then be encoded (i.e., block transformation, transform coefficient quantization, entropy encoding). The transform of a block converts the pixel values of a block from the spatial domain into a frequency domain for quantization; this takes advantage of decorrelation and energy compaction of transforms such as the two-dimensional discrete cosine transform (DCT) or an integer transform approximating a DCT. For example, in MPEG and H.263, 8×8 blocks of DCT-coefficients are quantized, scanned into a one-dimensional sequence, and coded by using variable length coding (VLC). H.264/AVC uses an integer approximation to a 4×4 DCT for each of sixteen 4×4 Y blocks and eight 4×4 chrominance blocks per macroblock. Thus, an inter-coded block is encoded as motion vector(s) plus quantized transformed residual block.

Similarly, intra-coded pictures may still have spatial prediction for blocks by extrapolation from already encoded portions of the picture. Typically, pictures are encoded in raster scan order of blocks, so pixels of blocks above and to the left of a current block can be used for prediction. Again, transformation of the prediction errors for a block can remove spatial correlations and enhance coding efficiency.

When a compressed, i.e., encoded, video stream is transmitted, parts of the data may be corrupted or lost. Compressed video streams are very sensitive to transmission errors because of the use of predictive coding and variable length coding by the encoder. The use of spatial and temporal prediction in compression can lead to propagation of errors when a single sample is lost. In addition, a single bit error can cause a decoder to lose synchronization due to the use of VLC. Therefore, error recovery techniques and error resilience in video decoders are very important.

### SUMMARY OF THE INVENTION

In general, the invention relates to a method for decoding an encoded video stream and a decoder and digital system configured to executed the method. The method includes when a sequence parameter set in the encoded video stream is lost, wherein the sequence parameter set includes a frame number parameter, a picture order count parameter, a picture height parameter, a picture width parameter, and a plurality of non-critical parameters, assigning default values to the plurality of non-critical parameters, and setting the picture height parameter and the picture width parameter based on a common pixel resolution. The method also includes when a slice header of an instantaneous decoding refresh picture is available, determining the frame number parameter from the slice header, and determining the picture order count parameter using the frame number parameter, the default values, the pixel height parameter, and the picture width parameter, and using the picture order count parameter, the frame number parameter, the default values, the pixel height parameter, and the picture width parameter to decode a slice in the encoded video stream.

### BRIEF DESCRIPTION OF THE DRAWINGS

Particular embodiments in accordance with the invention will now be described, by way of example only, and with reference to the accompanying drawings:

FIG. 1 shows a digital system including a video encoder and decoder in accordance with one or more embodiments of the invention;

FIG. 2 shows a block diagram of a video encoder in accordance with one or more embodiments of the invention;

FIG. 3 shows a block diagram of a video decoder in accordance with one or more embodiments of the invention;

FIG. 4 shows a flow diagram of a method for error recovery during frame boundary detection in accordance with one or more embodiments of the invention;

FIG. 5 shows a flow diagram of a method for recovery from a false access unit delimiter (AUD) in accordance with one or more embodiments of the invention;

FIG. 6 shows a flow diagram of a method for detection of false arbitrary slice order (ASO);

FIGS. 7A-7C show flow diagrams of a method for recovery from a lost sequence parameter set in accordance with one or more embodiments of the invention;

FIG. 8 shows a flow diagram of a method for temporal concealment in accordance with one or more embodiments of the invention;

FIG. 9 shows a flow diagram of a method for flow diagram of a method for reduction of smearing of black borders when concealment is used;

FIG. 10 shows a flow diagram of a method for scene change detection when block loss occurs in accordance with one or more embodiments of the invention;

FIG. 11 shows an example in accordance with one or more embodiments of the invention; and

FIG. 12 shows an illustrative digital system in accordance with one or more embodiments.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein. Further, while various embodiments of the invention are described herein in accordance with the H.264 video coding standard, embodiments for other video coding standards will be understood by one of ordinary skill in the art. Accordingly, embodiments of the invention should not be considered limited to the H.264 video coding standard.

In the description below, some terminology is used that is specifically defined in the H.264 video coding standard entitled “Advanced video coding for generic audiovisual services” by the International Telecommunication Union (ITU) Telecommunication Standardization Sector (ITU-T). This terminology is used for convenience of explanation and should not be considered as limiting embodiments of the invention to the H.264 standard. One of ordinary skill in the art will appreciate that different terminology may be used in other video encoding standards without departing from the described functionality.

In general, embodiments of the invention provide methods, decoders, and digital systems that apply one or more error recovery techniques for improved picture quality when decoding encoded digital video streams that may have been corrupted by transmission errors. An encoded video stream is a sequence of encoded video sequences. An encoded video sequence is a sequence of encoded pictures in which a picture may represent an entire frame or a single field of a frame. Further, the term frame may be used to refer to a picture, a frame, or a field. As was previously mentioned, a picture is decomposed into macroblocks for encoding. A picture may also be split into one or more slices for encoding, where a slice is a sequence of macroblocks. A slice may be an I slice in which all macroblocks are encoded using intra prediction, a P slice in which some of the macroblocks are encoded using inter prediction with one motion-compensated prediction signal, a B slice in which some macroblocks are encoded using inter prediction using two motion-compensated prediction signals, an SP slice which is a P slice coded for efficient switching between pictures, or an Si slice which is an I slice that allows an exact match of a macroblock in an SP slice for random access and error recovery purposes.

In one or more embodiments of the invention, pictures may be encoded using macroblock raster scan order, flexible macroblock order (FMO), or arbitrary slice order (ASO). FMO allows a picture to be divided into various scanning patterns such as interleaved slice, dispersed slice, foreground slice, leftover slice, box-out slice, and raster scan slice. ASO allows the slices of a picture to be coded in any relative order.

An encoded video sequence is transmitted as a NAL (network abstraction layer) unit stream that includes a series of NAL units. A NAL unit is effectively a packet that contains an integer number of bytes in which the first byte is a header byte indicating the type of data in the NAL unit and the remaining bytes are payload data of the type indicated. In some systems (e.g., H.320 or MPEG-2/H.222.0 systems), some or all of the NAL unit stream may be transmitted as an ordered stream of bytes or bits in which the locations of NAL units are identified from patterns within the stream. In this byte stream format, each NAL unit is prefixed by a pattern of three bytes, i.e., 0x000001, called a start code prefix. The boundaries of a NAL unit are thus identifiable by searching the byte stream for the start code prefixes. In other systems (e.g., IP/RTP systems), the NAL unit stream is carried in packets framed by the system transport protocol and identification of NAL units within the packets is accomplished without start code prefixes.

NAL units may be VCL (video coding layer) and non-VCL NAL units. VCL NAL units include the encoded pictures and the non-VCL NAL units include any associated additional information such as parameter sets and supplemental enhancement information. There are two types of parameter sets: sequence parameter sets which apply to a sequence of consecutive encoded pictures and picture parameter sets which apply to the decoding of one or more individual pictures in a sequence of encoded pictures. A sequence parameter set may include, for example, a profile and level indicator, information about the decoding method, the number of reference frames, the frame size in macroblocks, frame cropping information, and video usability information (VUI) parameters such as aspect ratio or color space. A picture parameter set may include, for example, an indication of entropy coding mode, information about slice data partitioning and macroblock reordering, an indication of the use of weighed prediction, and the initial quantization parameters. Each of these parameter sets is transmitted in its own uniquely identified NAL unit. Further, each VCL NAL unit includes an identifier that refers to the associated picture parameter set and each picture parameter set includes an identifier that refers to the associated sequence parameter set.

An encoded picture is transmitted in a set of NAL units called an access unit. That is, all macroblocks of the picture are included in the access unit and the decoding of an access unit yields a decoded picture. An access unit includes a primary coded picture, and possibly one or more of an access unit delimiter (AUD), supplemental enhancement information, a redundant coded picture, an end of sequence NAL unit, and an end or stream NAL unit. The primary coded picture is a set of VCL NAL units that include the encoded picture. The AUD indicates the start of the access unit. The supplemental enhancement information, if present, precedes the primary coded picture, and includes data such as picture timing information. The redundant coded picture, if present, follows the primary coded picture, and includes VCL NAL units with redundant representations of areas of the same picture. The redundant code pictures may be used by a decoder for error recovery. If the encoded picture is the last picture of a sequence of encoded pictures, the end of sequence NAL unit may be included in the access unit to indicate the end of the sequence. If the encoded picture is the last picture in the NAL unit stream, the end of stream NAL unit may be included in the access unit to indicate the end of the stream.

An encoded video sequence thus includes a sequence of access units in which an instantaneous decoding refresh (IDR) access unit is followed by zero or more non-IDR access units including all subsequent access units up to but not including the next IDR access unit. An IDR access unit is an access unit in which the primary coded picture is an IDR picture. An IDR picture is an encoded picture that includes only I or Si slices. Once an IDR picture is decoded, all subsequent encoded pictures (until the next IDR picture is decoded) can be decoded without inter prediction from any picture decoded prior to the IDR picture.

The error recovery techniques that may be applied by the decoder in one or more embodiments of the invention in response to transmission errors in a NAL unit stream include improved frame boundary detection, recovery from a false AUD, recovery from false arbitrary slice order (ASO) detection, recovery from a lost sequence parameter set or picture parameter set, improved temporal concealment, improved handling of black borders when applying concealment, and more robust scene change detection when block loss occurs. Each of these techniques is explained in more detail below.

Embodiments of the decoders and methods described herein may be provided on any of several types of digital systems (e.g., cell phones, video cameras, set-top boxes, notebook computers, etc.) that include any of several typed of hardware including, for example, digital signal processors (DSPs), general purpose programmable processors, application specific circuits, or systems on a chip (SoC) such as combinations of a DSP and a reduced instruction set (RISC) processor together with various specialized programmable accelerators. A stored program in an onboard or external (flash EEP) ROM or FRAM may be used to implement the video signal processing. Analog-to-digital converters and digital-to-analog converters provide coupling to the real world, modulators and demodulators (plus antennas for air interfaces) can provide coupling for transmission waveforms, and packetizers can provide formats for transmission over networks such as the Internet.

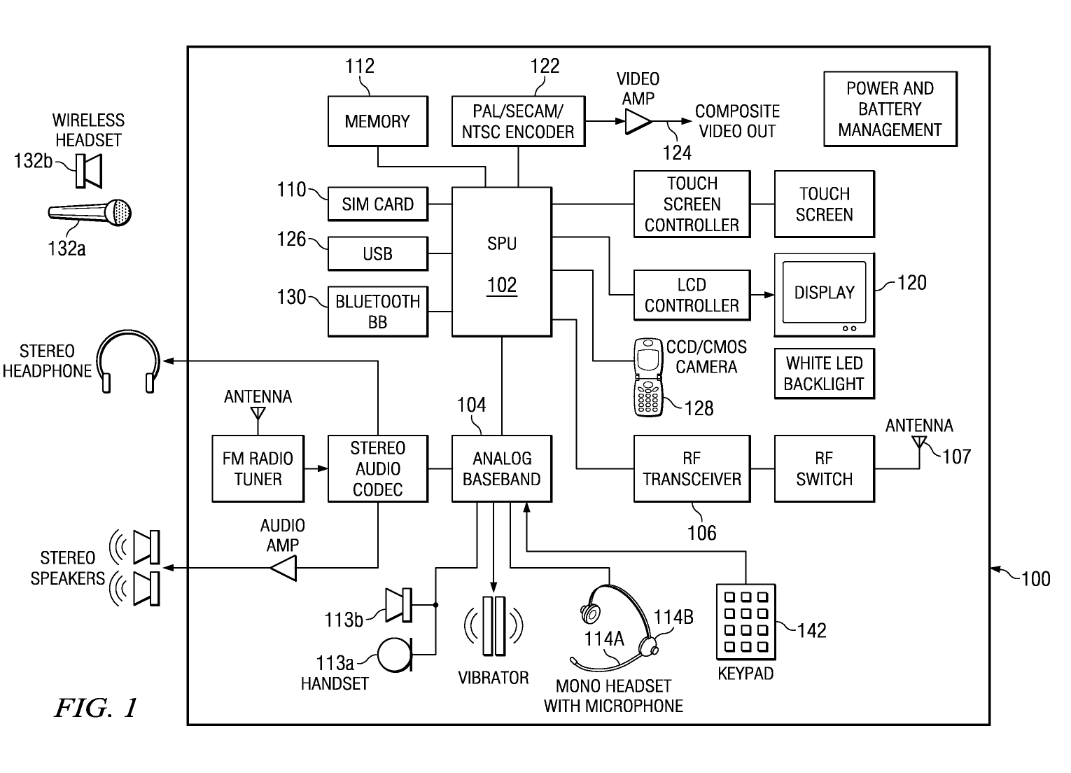

FIG. 1 is a block diagram of a digital system (e.g., a mobile cellular telephone) (100) may be configured to perform all or any combination of the error recovery methods described herein. The signal processing unit (SPU) (102) includes a digital processing processor system (DSP) that includes embedded memory and security features. The analog baseband unit (104) receives a voice data stream from handset microphone (113a) and sends a voice data stream to the handset mono speaker (113b). The analog baseband unit (104) also receives a voice data stream from the microphone (114a) and sends a voice data stream to the mono headset (114b). The analog baseband unit (104) and the SPU (102) may be separate ICs. In many embodiments, the analog baseband unit (104) does not embed a programmable processor core, but performs processing based on configuration of audio paths, filters, gains, etc being setup by software running on the SPU (102). In some embodiments, the analog baseband processing is performed on the same processor and can send information to it for interaction with a user of the digital system (100) during a call processing or other processing.

The display (120) may also display pictures and video streams received from the network, from a local camera (128), or from other sources such as the USB (126) or the memory (112). The SPU (102) may also send a video stream to the display (120) that is received from various sources such as the cellular network via the RF transceiver (106) or the camera (126). The SPU (102) may also send a video stream to an external video display unit via the encoder (122) over a composite output terminal (124). The encoder unit (122) may provide encoding according to PAL/SECAM/NTSC video standards.

The SPU (102) includes functionality to perform the computational operations required for video compression and decompression. The video compression standards supported may include, for example, one or more of the JPEG standards, the MPEG standards, and the H.26x standards. In one or more embodiments of the invention, the SPU (102) is configured to perform the computational operations of one or more of the error recovery methods described herein. Software instructions implementing the one or more error recovery methods may be stored in the memory (112) and executed by the SPU (102) during decoding of video sequences.

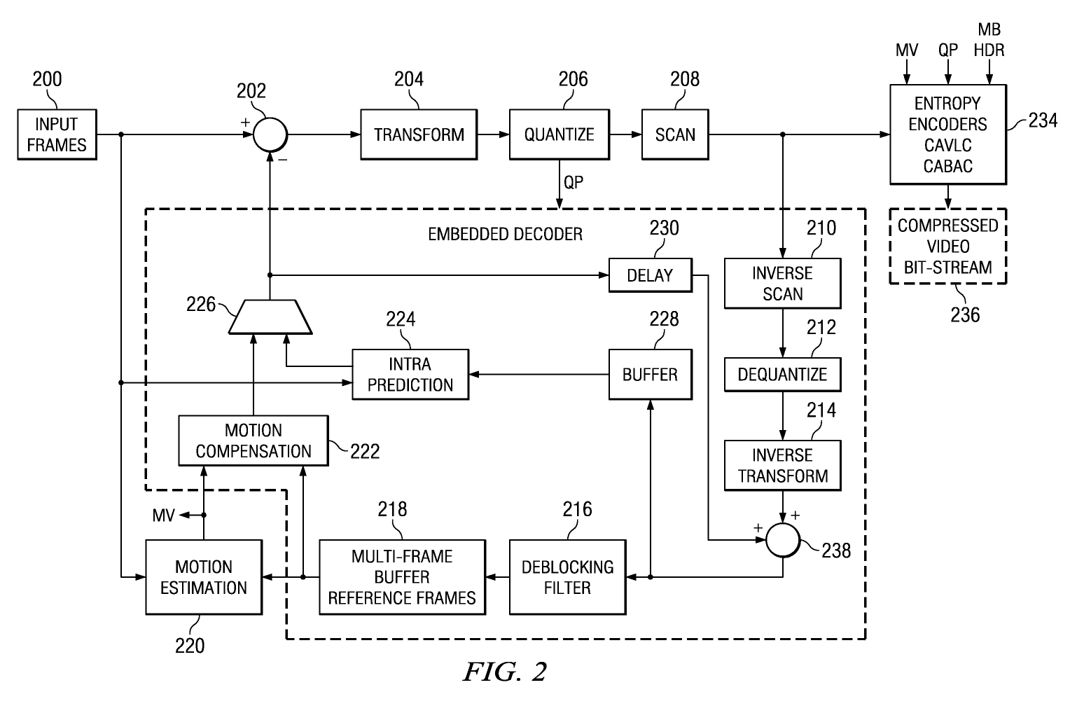

FIG. 2 shows a block diagram of a video encoder in accordance with one or more embodiments of the invention. More specifically, FIG. 2 shows the basic coding architecture of an H.264 encoder. In one or more embodiments of the invention, this architecture may be implemented in hardware and/or software on the digital system of FIG. 1.

In the video encoder of FIG. 2, input frames (200) for encoding are provided as one input of a motion estimation component (220), as one input of an intraframe prediction component (224), and to a positive input of a combiner (202) (e.g., adder or subtractor or the like). The frame storage component (218) provides reference data to the motion estimation component (220) and to the motion compensation component (222). The reference data may include one or more previously encoded and decoded frames. The motion estimation component (220) provides motion estimation information to the motion compensation component (222) and the entropy encoders (234). Specifically, the motion estimation component (220) provides the selected motion vector (MV) or vectors and the selected mode to the motion compensation component (222) and the selected motion vector (MV) to the entropy encoders (234). The motion compensation component (222) provides motion compensated prediction information to a selector switch (226) that includes motion compensated interframe macroblocks and the selected mode. The intraframe prediction component also provides intraframe prediction information to switch (226) that includes intraframe prediction macroblocks.

The switch (226) selects between the motion-compensated interframe macro blocks from the motion compensation component (222) and the intraframe prediction macroblocks from the intraprediction component (224) based on the selected mode. The output of the switch (226) (i.e., the selected prediction MB) is provided to a negative input of the combiner (202) and to a delay component (230). The output of the delay component (230) is provided to another combiner (i.e., an adder) (238). The combiner (202) subtracts the selected prediction MB from the current MB of the current input frame to provide a residual MB to the transform component (204). The transform component (204) performs a block transform, such as DCT, and outputs the transform result. The transform result is provided to a quantization component (206) which outputs quantized transform coefficients. Because the DCT transform redistributes the energy of the residual signal into the frequency domain, the quantized transform coefficients are taken out of their raster-scan ordering and arranged by significance, generally beginning with the more significant coefficients followed by the less significant by a scan component (208). The ordered quantized transform coefficients provided via a scan component (208) are coded by the entropy encoder (234), which provides a compressed bitstream (236) for transmission or storage.

Inside every encoder is an embedded decoder. As any compliant decoder is expected to reconstruct an image from a compressed bitstream, the embedded decoder provides the same utility to the video encoder. Knowledge of the reconstructed input allows the video encoder to transmit the appropriate residual energy to compose subsequent frames. To determine the reconstructed input, the ordered quantized transform coefficients provided via the scan component (208) are returned to their original post-DCT arrangement by an inverse scan component (210), the output of which is provided to a dequantize component (212), which outputs estimated transformed information, i.e., an estimated or reconstructed version of the transform result from the transform component (204). The estimated transformed information is provided to the inverse transform component (214), which outputs estimated residual information which represents a reconstructed version of the residual MB. The reconstructed residual MB is provided to the combiner (238). The combiner (238) adds the delayed selected predicted MB to the reconstructed residual MB to generate an unfiltered reconstructed MB, which becomes part of reconstructed frame information. The reconstructed frame information is provided via a buffer (228) to the intraframe prediction component (224) and to a filter component (216). The filter component (216) is a deblocking filter (e.g., per the H.264 specification) which filters the reconstructed frame information and provides filtered reconstructed frames to frame storage component (218).

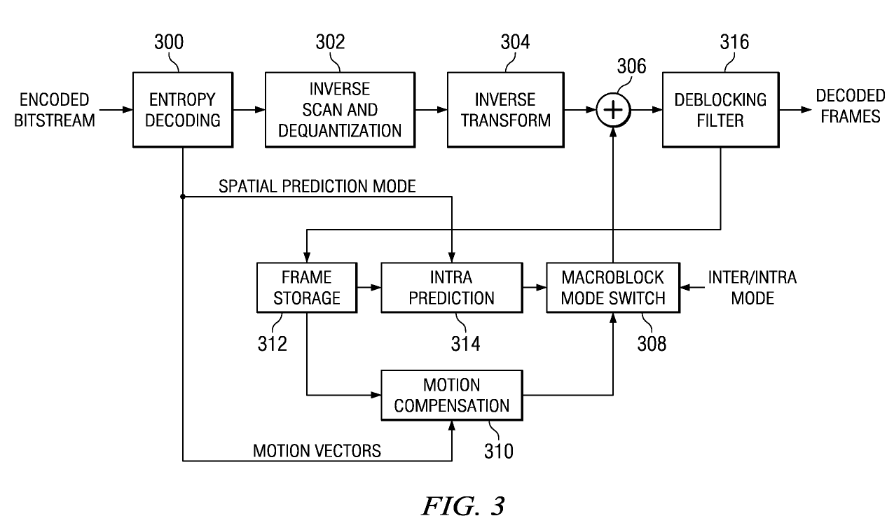

FIG. 3 shows a block diagram of a video decoder in accordance with one or more embodiments of the invention. More specifically, FIG. 3 shows the basic decoding architecture of an H.264 decoder. In one or more embodiments of the invention, this architecture may be implemented in hardware and/or software on the digital system of FIG. 1.

The entropy decoding component 300 receives the encoded video bitstream and recovers the symbols from the entropy encoding performed by the encoder. Error detection and recovery as described below may be included in or after the entropy decoding. The inverse scan and dequantization component (302) assembles the macroblocks in the video bitstream in raster scan order and substantially recovers the original frequency domain data. The inverse transform component (304) transforms the frequency domain data from inverse scan and dequantization component (302) back to the spatial domain. This spatial domain data supplies one input of the addition component (306). The other input of addition component (306) comes from the macroblock mode switch (308). When in inter prediction mode is signaled in the encoded video stream, the macroblock mode switch (308) selects the output of the motion compensation component (310). The motion compensation component (310) receives reference frames from frame storage (312) and applies the motion compensation computed by the encoder and transmitted in the encoded video bitstream. When intra prediction mode is signaled in the encoded video stream, the macroblock mode switch (308) selects the output of the intra prediction component (314). The intra prediction component (314) applies the intra prediction computed by the encoder and transmitted in the encoded video bitstream.

The addition component (306) recovers the predicted frame. The output of addition component (306) supplies the input of the deblocking filter component (316). The deblocking filter component (316) smoothes artifacts created by the block and macroblock nature of the encoding process to improve the visual quality of the decoded frame. In one or more embodiments of the invention, the deblocking filter component (316) applies a macroblock-based loop filter for regular decoding to maximize performance and applies a frame-based loop filter for frames encoded using flexible macroblock ordering (FMO) and for frames encoded using arbitrary slice order (ASO). The macroblock-based loop filter is performed after each macroblock is decoded, while the frame-based loop filter delays filtering until all macroblocks in the frame have been decoded.

More specifically, because a deblocking filter processes pixels across macroblock boundaries, the neighboring macroblocks are decoded before the filtering is applied. In some embodiments of the invention, performing the loop filter as each macroblock is decoded has the advantage of processing the pixels while they are in on-chip memory, rather than writing out pixels and reading them back in later, which consumes more power and adds delay. However, if macroblocks are decoded out of order, as with FMO or ASO, the pixels from neighboring macroblocks may not be available when the macroblock is decoded; in this case, macroblock-based loop filtering cannot be performed. For FMO or ASO, the loop filtering is delayed until after all macroblocks are decoded for the frame, and the pixels must be reread in a second pass to perform frame-based loop filtering. The output of the deblocking filter component (316) is the decoded frames of the video bitstream. Each decoded frame is stored in frame storage (312) to be used as a reference frame.

Various methods for error recovery during decoding of encoded video sequences are now described. Each of these methods may be used alone or in combination with one or more of the other methods in embodiments of the invention.

### Frame Boundary Detection

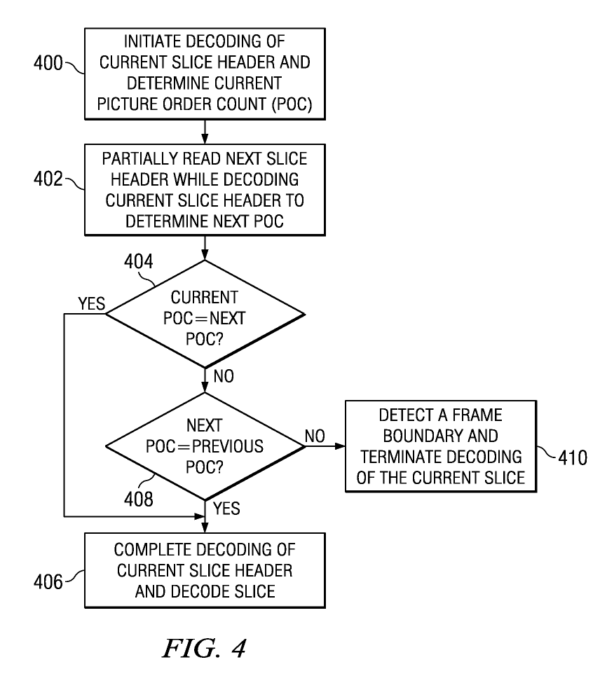

FIG. 4 is a flow graph of a method for error recovery during frame boundary detection in accordance with one or more embodiments of the invention. Each slice in an encoded frame is preceded by a slice header that includes information for decoding the macroblocks in the slice. The slice header information includes one or more values that may be decoded to determine a picture order count (POC). The POC for each slice in a single frame is the same. In addition, the POC increases incrementally for each frame in a video sequence. In embodiments of the invention, a frame boundary is detected when the picture order count (POC) for a slice is different from that of the previous slice. However, to allow for the possibility that the information in the slice header used to determine the POC may be corrupted, the POC for the next slice is checked before allowing a frame boundary to be detected.

More specifically, as shown in FIG. 4, decoding of the header of the current slice is initiated and the POC for the current slice is determined (400). Concurrently, the header of the next slice in the video sequence is partially read (i.e., the header is read from the beginning until the values needed for determining the POC are read) to determine the POC for the next slice (402). If the POC for the current slice is the same as the POC for the next slice (404), a frame boundary is not detected and decoding of the current slice header and the slice is completed (406). However, if the two POCs are different, the POC for the next slice is compared to the POC of the previous slice, i.e., the slice immediately preceding the current slice (408). If the POC for the next slice is the same as the POC for the previous slice, the information used for determining the POC of the current slice is assumed to be corrupted, a frame boundary is not detected, and decoding of the current slice header and the slice is completed (406). If the POC for the next slice is not the same as the POC for the previous slice (408), then a frame boundary is detected and decoding of the current slice is terminated (410).

Table 1 shows two examples of this method for frame boundary detection. Example 1 is a video sequence in which each frame has multiple slices and Example 2 is a video sequence in which each frame has only one slice. The horizontal and vertical lines represent frame boundaries. In each example, the top line is the example video sequence and the line below show the slice headers read for each pass through the method, i.e., for each slice. S*a indicates decoding a partial slice header (the first part), and S*b indicates decoding the last part of the slice header. Example 1 illustrates that in multiple-slice frames, for all slices except the first two slices (S5, S6, S9, S10) in a frame, the slice header only partially read once as the next slice, and is fully reads once for the actual decoding. However, except for the first frame, the first and second slice (S5, S6, S9, S10) in all frames are partially read two times because of the duplication due to frame boundary detection. Example 2 illustrates that in single-slice frames, except for the first two frames (S1, S2), all slices are partially read three times, plus one full read for decoding. In one or more embodiments of the invention, partial reads are reduced by including an additional condition to only read the next slice header if the current slice is not the first slice in a frame, since there is no need to detect a frame boundary when decoding the first slice in a frame.

TABLE 1

Example 1: Multiple-slice frames
S1 S2 S3 S4|S5 S6 S7 S8|S9 S10 S11 S12|S13 S14 . . .
S1a S2a S1b = S2a S1
S2a S3a S2b = S3a S2
S3a S4a S3b = S4a S3
S4a S5a S4b = S5a S4
S5a S6a
S5a S6a S5b = S6a S5
S6a S7a S6b = S7a S6
S7a S8a S7b = S8a S7
S8a S9a S8b = S9a S8
S9a S10a
S9a S10a S9b
S10a S11a S10b
S11a S12a S11b
S12a S13a S12b
S13a S14a
Example 2: Single-slice frames
S1|S2|S3|S4|S5
S1a S2a S1b = S2a S1
S2a S3a
S2a S3a S2b = S3a S2
S3a S4a
S3a S4a S3b = S4a S3
S4a S5a
S4a S5a S4b = S5a S4
S5a S6a

Recovery from False AUD

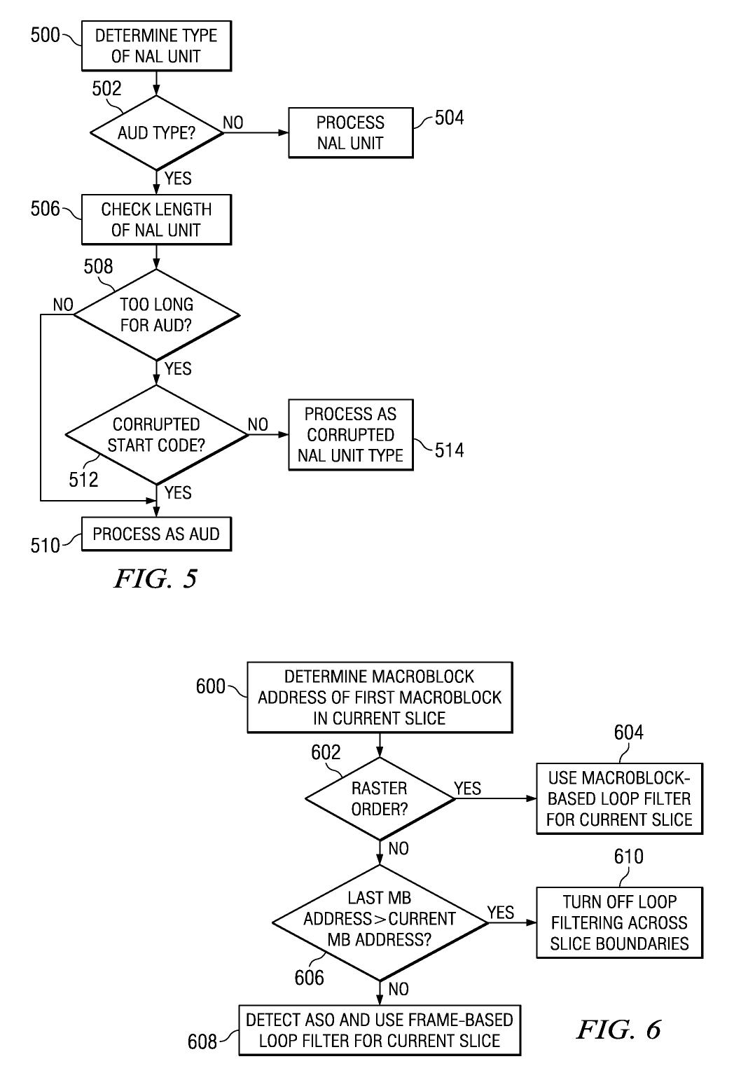

In some encoded video sequences, an access unit delimiter (AUD) is placed at the beginning of each access unit to indicate the boundary between access units. In one or more embodiments of the invention, an access unit delimiter is a NAL unit that includes a start code, e.g., 0x000001, a NAL unit type indicating the NAL unit is an AUD, and may also include information that specifies the type of slices present in the primary coded picture of the access unit. If the type of a NAL unit is corrupted, the corruption could cause an AUD to be detected in the wrong place (i.e., an emulated AUD) which would erroneously terminate the decoding of the primary coded picture. FIG. 5 is a flow diagram of a method for recovery from a false access unit delimiter (AUD) in accordance with one or more embodiments of the invention.

For each NAL unit in an encoded video sequence, the type of the NAL unit is determined (500). If the type is not that of an AUD (502), then the NAL unit is processed according to its type (504). However, if the type of the NAL unit is that of an AUD (502), additional checks are performed to verify that the NAL unit is a true AUD. First, the length of the NAL unit is checked to see it conforms with the expected length of an AUD (506). In one or more embodiments of the invention, the expected length of an AUD may be five bytes or six bytes. If the length of the NAL unit does not exceed the expected length for an AUD (508), then the NAL unit is processed as an AUD (510).

If the length of the NAL unit exceeds the expected length of an AUD (508), then either the type of the NAL unit is corrupted or the start code of the next NAL unit is corrupted. First, a check is made to determine if the start code, e.g., 0x000001, of the next NAL unit is corrupted (512). In one or more embodiments of the invention, if the number of ones in the three bytes that should contain the start code of the next NAL unit, i.e., the Hamming weight of the three bytes, is less than a threshold, e.g., 6, the start code is assumed to be corrupted and the NAL unit is processed as an AUD (510). Otherwise, the NAL unit is processed as having a corrupted NAL unit (514). In the latter case, since the type of the NAL unit is corrupted, the NAL unit cannot be decoded and is marked for concealment.

Table 2 shows two examples of NAL units in an encoded video stream with corruption. The value that is detected as the type, i.e., 9, of the NAL unit is bolded. In the top example, the method of FIG. 5 detects an AUD followed by a corrupted start code. In the bottom example, the method of FIG. 5 detects a corrupted NAL unit type.

TABLE 2

0x00 00 01 29 30 00 00 11 . . .
0x00 00 01 29 01 2f 84 10 . . .

Recovery from False Arbitrary Slice Order (ASO) Detection

In one or more embodiments of the invention, slices of a picture may be encoded in any relative order, i.e., in arbitrary slice order (ASO). In such embodiments, a macroblock-based loop deblocking filter is used for pictures encoded in raster scan order and a frame-based loop deblocking filter is used for pictures encoded in arbitrary slice order. However, there is no specific indicator in an encoded video stream to signal that ASO is used for an encoded picture so detection of ASO must be derived from other indicators in the encoded video stream. For example, ASO may be detected when the macroblock address of the last macroblock of the previously decoded slice and the macroblock address of the first macroblock in the current slice are not in raster order. However, corruption in the encoded video stream could corrupt these indicators and cause a false detection of ASO. False detection of ASO would cause the frame-based loop filter to be used which may cause artifacts in the decoded picture.

FIG. 6 is a flow diagram of a method for detection of false ASO in accordance with one or more embodiments of the invention. Initially, the macroblock address of the first macroblock in the current slice is determined (600). A macroblock address is the index of a macroblock in the encoded picture. In some embodiments of the invention, the macroblock address of the first macroblock in the current slice is read from the header of the current slice (e.g., first_mb_in_slice). If the macroblock address of the first macroblock in the current slice and the macroblock address of the last macroblock decoded in the previous slice, i.e., the last macroblock parsed in the previous slice, even if parsing stops because an error is detected, follow raster order (602), then ASO mode is not detected and the macroblock based loop deblocking filter is used for the current slice (604).

If the two macroblock addresses do not follow raster order (602), ASO mode may be possibly be indicated. However, another check is made before ASO is assumed. If the macroblock address of the last macroblock decoded in the previous slice is greater than the macroblock address of the first macroblock in the current slice (606), the previous slice is assumed to be corrupted and ASO mode is not detected. To avoid using corrupted data, all deblocking filtering across slice boundaries is disabled (e.g., disable_deblocking_filter_idc is set to 2). If the macroblock address of the last macroblock decoded in the previous slice is not greater than the macroblock address of the first macroblock in the current slice (606), ASO is detected and the frame-based loop deblocking filter is used for the current slice (608).

Recovery from Lost Sequence Parameter Set or Lost Picture Parameter Set

The sequence parameter set (SPS) and picture parameter set (PPS) contain information necessary to decode an encoded video stream. In one or more embodiments of the invention, if the SPS and/or PPS is corrupted with bit errors or dropped due to packet loss, default values are assumed for the parameters and an attempt is made to decode the encoded video stream. More specifically, in one or more embodiments of the invention, if the PPS is lost (e.g., a slice header refers to a PPS that has not been detected), default values are assumed for the parameters in the PPS and an attempt is made to decode the one or more pictures to which the PPS applies. Table 3 shows pseudocode for setting the default picture parameter values that are used in some embodiments of the invention. In one or more embodiments of the invention, the default values are selected assuming the baseline profile of the decoding standard in use. In some embodiments of the invention, multiple PPS and SPS are permitted and a table stores the parameter sets. This table is made larger by one entry to hold the default values in the last entry. The parameters NPPS and nSPS in the pseudocode indicate how many values are stored. For example, if NSPS is 16, indices 0-15 in the table are the parameters for decoding the stream and entry 16 contains default values.

TABLE 3

Void LoadDefaultPPS (DPBMgmtState_t * DPBMgmtState,

PIC_PARS * pic_pars, U16 nSPS)

{

pic_pars->pic_parameter_set_id = NPPS;
pic_pars->seq_parameter_set_id = nSPS;
pic_pars->entropy_coding_mode_flag = 0;
pic_pars->pic_order_present_flag = 0;
pic_pars->num_slice_groups_minus1 = 0;
pic_pars->num_ref_idx_10_active_minus1 = 0;
pic_pars->num_ref_idx_11_active_minus1 = 0;
pic_pars->weighted_pred_flag = 0;
pic_pars->weighted_bipred_idc = 0;
pic_pars->pic_init_qp_minus26 = 0;
pic_pars->pic_init_qs_minus26 = 0;
pic_pars->chroma_qp_index_offset = 0;
pic_pars->deblocking_filter_control_flag_present = 0;
pic_pars->constrained_intra_pred_flag = 0;
pic_pars->redundant_pic_cnt_present_flag = 0;

StoreSPSPPS(DPBMgmtState->PPSBuffer + NPPS *

DPBMgmtState->PPSsize, (void *)pic_pars,
DPBMgmtState->PPSsize);

}

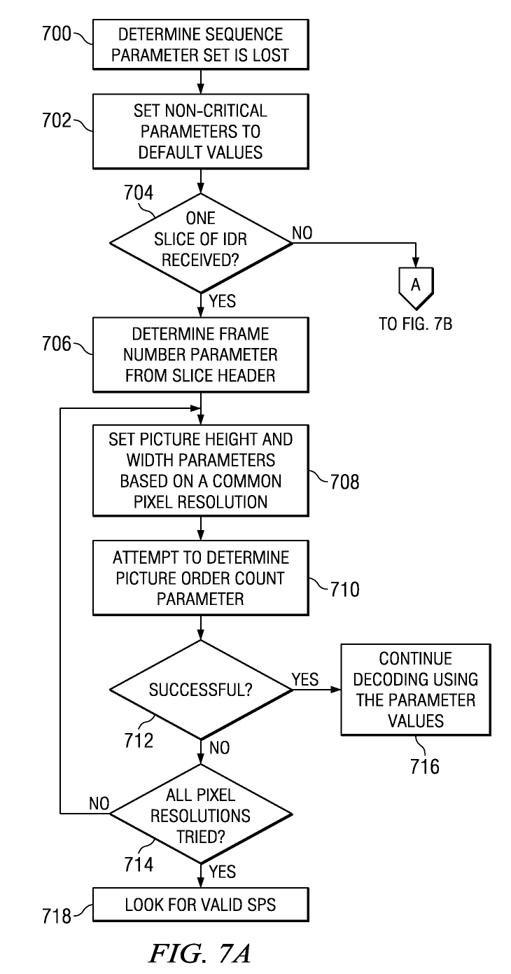

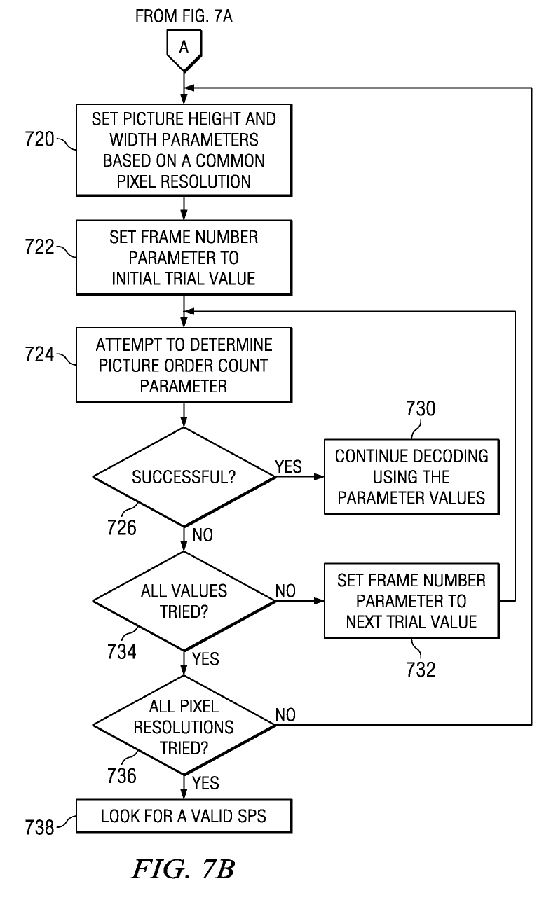

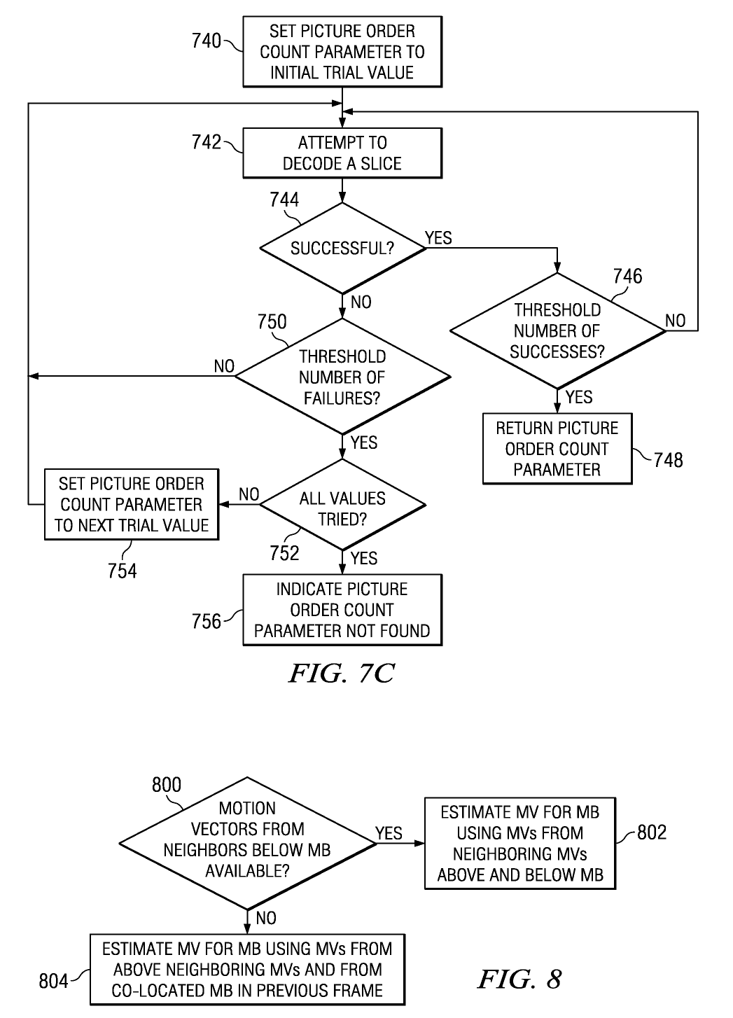

FIGS. 7A-7C are flow diagrams of a method for recovery from a lost SPS in accordance with one or more embodiments of the invention. In general, most parameter values in the SPS have fairly common values, i.e., their values are not critical to successful decoding, but the values of four of the parameters, a frame number parameter (e.g., log2_max_frame_num_minus4), a picture order count parameter (e.g., log2_max_pic_order_cnt_lsb_minus4), a picture height parameter (e.g., pic_height_in_map_units_minus1), and a picture width parameter (e.g., pic_width_in_mbs_minus1) are necessary for correct parsing and/or decoding. In the H.264 standard, log2_max_frame_num_minus4 indicates the number of bits used to represent a frame number (minus 4), and log2_max_pic_order_cnt_lsb_minus4 indicates the number of bits used to represent the least significant bits of the picture order count. For example, a value of 0 for log2_max_frame_num_minus4 means to read 4 bits from the bitstream for the frame number, and a value of 1 means to read 5 bits for the frame number. Therefore, when an SPS is lost, reasonable default values may be assigned to the non-critical parameters but the four critical parameters, values that yield successful decoding must be determined in some way. The method of FIGS. 7A-7C provides a way to determine values for these four parameters that may be used to successfully decode slices.

More specifically, as shown in FIG. 7A, a determination is made that an SPS has been lost (700), e.g., a slice header is decoded that references an SPS that has not been detected. When an SPS is lost, the non-critical parameters are set to default values (702). Table 4 shows pseudocode for setting the default values for the non-critical parameters that are used in some embodiments of the invention. In one or more embodiments, these default values are selected based on the values most likely to be used for encoding video streams to be played on cellular telephones. In other embodiments of the invention, different default values may be used for other applications, such as downloading newscasts, etc. How the four critical parameters are determined depends on whether or not at least one slice of the instantaneous decoding refresh (IDR) picture that would have followed the SPS in the encoded video sequence has been successfully received.

TABLE 4
Void LoadDefaultSPS(DPBMgmtState_t * DPBMgmtState,

SEQ_PARS * seq_pars, U16 nSPS,

U16 mb_width, U16 mb_height)

{

seq_pars->profile_idc = BASELINE_PROFILE_IDC;
seq_pars->constraint_set0_flag = 0;
seq_pars->constraint_set1_flag = 0;
seq_pars->constraint_set2_flag = 0;
seq_pars->constraint_set3_flag = 0;
seq_pars->level_idc = 20;
seq_pars->seq_parameter_set_id = nSPS;
seq_pars->log2_max_frame_num_minus4 = 0; /* JM, affects
parsing */
seq_pars->MaxFrameNum = 1 <<

(seq_pars->log2_max_frame_num_minus4 + 4); /* derived */

seq_pars->pic_order_cnt_type = 0;
seq_pars->log2_max_pic_order_cnt_lsb_minus4 = 0; /* JM,
affects parsing */
seq_pars->num_ref_frames = 1;
seq_pars->gaps_in_frame_num_value_allowed_flag = 0;
seq_pars->pic_width_in_mbs_minus1 = mb_width − 1;
seq_pars->pic_height_in_map_units_minus1 = mb_height − 1;
seq_pars->frame_mbs_only_flag = 1;
seq_pars->direct_8×8_inference_flag = 0;
seq_pars->frame_cropping_flag = 0;
seq_pars->vui_parameters_present_flag = 0;
StoreSPSPPS(DPBMgmtState->SPSBuffer +

nSPS * DPBMgmtState->SPSsize,

(void *)seq_pars, DPBMgmtState->SPSsize);

}

If a slice has been successfully received (704), then the frame number parameter is determined from the slice header (706). In one or more embodiments of the invention, the assumption is made that every encoded picture contains only encoded frame macroblocks and not encoded fields. Once the frame number parameter is determined, an attempt is made to derive the picture order count parameter using values for the picture height and picture width parameters based on one or more common pixel resolutions used in video streams. In one or more embodiments of the invention, the common pixel resolutions used are based on Common Intermediate Format (CIF) and Quarter Common Intermediate Format (QCIF). CIF defines a video sequence with a resolution of 352×288 and a frame rate of 300000/1001 frames per second. QCIF defines a video sequence with a resolution of 176×144 and a frame rate of 30 frames per second.

More specifically, the picture height and width parameters are set based on one common pixel resolution (e.g., QCIF) (708), and an attempt is made to determine a successful value for the picture order count parameter using the value determined for the frame number parameter, and the values of the picture height and width parameters (710). The process for attempting the determination is described below in relation to FIG. 7C. If the attempt is successful (712), decoding of the encoded video stream is continued (716) using the current values of the non-critical parameters, the frame number parameter, the picture height and width parameters and the value determined for the picture order count parameter. If the attempt is not successful (712), then a check is made to determine if all of the common pixel resolutions that are to be tried have been tried (714). If all of the common pixel resolutions have been tried (714), then decoding of the video stream switches to looking for a valid SPS in the stream (718). If there is still another common pixel resolution to be tried (714), then the picture height and width parameters are set based on the next common pixel resolution (e.g., QCIF) (708) and another attempt is made to determine the picture order count parameter (710).

If a slice of the IDR picture has not been successfully received (704), then a value for the frame number parameter is determined without relying on information in the slice header, as well as values for the other three critical parameters. As shown in FIG. 7B, attempts are made to determine values for both the frame number parameter and the picture order count parameter using values for the picture height and picture width parameters based on one or more common pixel resolutions used in video streams. More specifically, the picture height and width parameters are set based on one common pixel resolution (e.g., QCIF) (720), and attempts are made to determine a successful value for the frame number parameter and the picture order count using the values of the picture height and width parameters. The frame number parameter is set to an initial trial value (722), e.g., 0, and an attempt is made to determine a successful value for the picture order count parameter using the current value of the frame number parameter, and the values of the picture height and width parameters (724). The process for attempting the determination is described below in relation to FIG. 7C. If the attempt is successful (726), decoding of the encoded video stream is continued (730) using the current values of the non-critical parameters, the frame number parameter, the picture height and width parameters and the value determined for the picture order count parameter.

If the attempt is not successful (726), a check is made to determine if all values of the frame number parameter to be tried have been tried (734). If all values have not been tried (734), the frame number parameter is set to the next trial value (732) and another attempt is made to determine a value for the picture order count parameter (724). In one or more embodiments of the invention, the possible values of the frame number parameter are 0 through 12, inclusive. If all values have been tried (734), then a check is made to determine if all of the common pixel resolutions that are to be tried have been tried (736). If all of the common pixel resolutions have been tried (736), then decoding of the video stream switches to looking for a valid SPS in the stream (738). If there is still another common pixel resolution to be tried (734), then the picture height and width parameters are set based on the next common pixel resolution (e.g., QCIF) (720) and another attempt is made to derive values for both the frame number parameter and the picture order count parameter using values for the picture height and picture width parameters based on the next common pixel resolution (722).

FIG. 7C is a flow diagram of a method for attempting to determine a successful value for the picture order count parameter using the current values of the frame number parameter and the picture height and width parameters. The picture order count is set to an initial trial value (e.g., 0) (740), and an attempt is made to decode a slice using the current values of the SPS parameters (742). If a slice is successfully decoded (744) and a number of slices equal to a decode success threshold (e.g., successful decoding of two slices) have been successfully decoded using the current values (746), then the current value of the picture order count parameter is returned to indicate a successful value for the parameter has been determined (748). If a slice is successfully decoded (744) and a number of slices equal to a decode success threshold (e.g., successful decoding of two slices) has not yet been successfully decoded using the current values (746), then an attempt is made to decode another slice using the current values of the parameters (742).

If the slice is not successfully decoded (744) and a number of slices equal to a decode failure threshold (e.g., failure to decode four slices) have not yet been unsuccessfully decoded using the current SPS parameter values (750), then an attempt is made to decode another slice using the current values of the parameters (742). If the slice is not successfully decoded (744) and a number of slices equal to a decode failure threshold (e.g., failure to decode four slices) have been unsuccessfully decoded using the current SPS parameter values (750), then a check is made to determine if all values of the picture order count parameter to be tried have been tried (752). If all values have not been tried (752), the picture order count parameter is set to the next trial value (754) and another attempt is made to decode a slice using the current parameter values (742). In one or more embodiments of the invention, the possible values of the picture order count parameter are 0 through 12, inclusive. If all values have been tried (752), then an indication that a successful value for the picture order count parameter was not found (756).

In one or more embodiments of the invention, if the SPS and PPS are both lost, the above method is executed assuming that the entropy encoding mode for the encoded video stream is context-adaptive variable-length coding (CAVLC). If the method completes without finding a combination of the four critical parameters that successfully decodes slices, then the method is tried again assuming that the entropy encoding mode is context-adaptive binary arithmetic coding (CABAC) if the PPS and the SPS were both lost. Note that if the PPS is not lost, the entropy encoding mode is known.

### Temporal Concealment

The loss or corruption of data in an encoded video stream may cause one or more macroblocks in a picture to be lost, i.e., the macroblock is dropped or corrupted. In general, concealment techniques are used during decoding to replace the lost macroblocks. Two commonly used concealment techniques are spatial concealment and temporal concealment. In general, spatial concealment estimates lost pixel values in a picture from pixel values in other areas of the same picture relying on similarity between neighboring regions in the spatial domain and temporal concealment estimates the lost pixel values from other pictures in the encoded video stream having temporal redundancy, i.e., motion vector information is used to estimate the lost values. Some techniques for spatial concealment are described in more detail in U.S. Patent Application No. 2008/0084934, which is incorporated herein by reference

FIG. 8 is a flow diagram of a method for temporal concealment in accordance with one or more embodiments of the invention. This method is performed when a macroblock is lost and temporal concealment is to be used to estimate the macroblock. As is shown in FIG. 8, if motion vectors (MVs) are available for macroblocks in the row immediately below the lost macroblock, i.e., neighboring macroblocks in the row below the lost macroblock, in the current frame (800), the motion vector for the lost macroblock is estimated using at least some of the motion vectors from the neighboring motion vectors above and below the missing macroblock (802). For example, the median of up to three motion vectors of neighboring macroblocks may be used to estimate the motion vector for the missing macroblock. In some embodiments of the invention in which multiple reference frames are allowed, the neighboring macroblocks used to estimate the motion vector for the missing macroblock are required to have the same reference frame. More specifically, an upper neighboring macroblock, e.g., the macroblock immediately above the missing macroblock, is selected for use in the estimate of the motion vector of the missing macroblock. Other neighboring macroblocks chosen for the estimate must have the same reference frame as the initially selected upper neighboring macroblock.

In some embodiments of the invention, the initial choice for the three motion vectors is the motion vector of the macroblock immediately above the missing macroblock, the motion vector of the macroblock immediately above and to the right of the missing macroblock, and the motion vector of the closest uncorrupted macroblock directly below the missing macroblock. If some of these macroblocks have different reference frames or are not available, the motion vectors of other neighboring macroblocks with the same reference frame, e.g., upper left instead of upper right, or below right instead of directly below, or below left if below right is not available are used.

If motion vectors are not available for the row immediately below the missing macroblock (800), the motion vector for the lost macroblock is estimated using the motion vector of the co-located macroblock from the previous reference frame (804). More specifically, the motion vector of the co-located macroblock along with the motion vector of the macroblock immediately above the missing macroblock in the current frame and the motion vector of the macroblock immediately above and to the right of the missing macroblock are used to estimate the motion vector of the missing macroblock. If any of these motion vectors are not available, the global motion vector for the frame is used in place of the unavailable motion vector. The reference frames for the macroblocks used to estimate the missing macroblock may be different. Some techniques for estimating the motion vector for the missing macroblock using these three motion vectors are described in more detail in U.S. Patent Application No. 2008/0084934, which is incorporated herein by reference.

### Black Borders

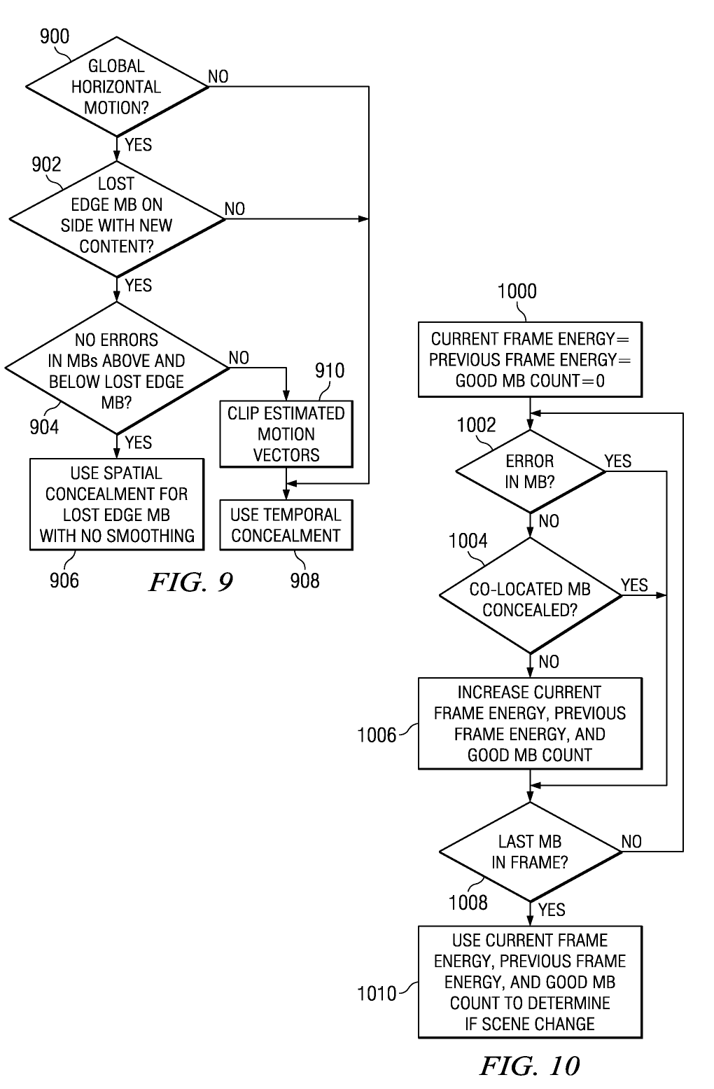

Some encoded video sequences may have a black border, which may smear into frames if temporal concealment is used. This problem is especially prevalent when panning is used. FIG. 9 shows a flow diagram of a method for reducing smearing of black borders when concealment is used. In general, spatial concealment is used for lost edge macroblocks when there is horizontal global motion and certain conditions are met and temporal concealment is used otherwise. More specifically, if there is horizontal motion in the global motion vector of the frame (900) and an edge macroblock on the side of a picture where new content is coming in is lost (902), then spatial concealment may be considered for the lost edge macroblock. In one or more embodiments of the invention, a global motion vector for the frame is computed using all macroblocks in the frame with no detected errors and horizontal motion is detected if the x-component of the global motion vector is non-zero. Further, an edge macroblock is a macroblock on the left edge of the picture when the camera pans to the left and/or the scene shifts horizontally to the right or a macroblock on the right edge of the picture when the camera pans to the right and/or the scene shifts to the left. In both cases, new scenery comes into the picture on the corresponding edge.

If the above conditions are met, then a check is made for errors in the macroblocks immediately above and below the lost edge macroblock in the picture (904). If there are no errors in these macroblocks, then spatial concealment with no smoothing is applied for the lost edge macroblock using these macroblocks (906). If any or all of the above conditions are not met (900, 902, 904), then temporal concealment is used (908). If there is global motion (900), and a lost macroblock is on the side with new content (902), but the macroblocks above and below are not error free (904), the estimated motion vectors are clipped (910) so that they do not point outside the frame before doing temporal concealment.

Scene Change Detection when Block Loss Occurs

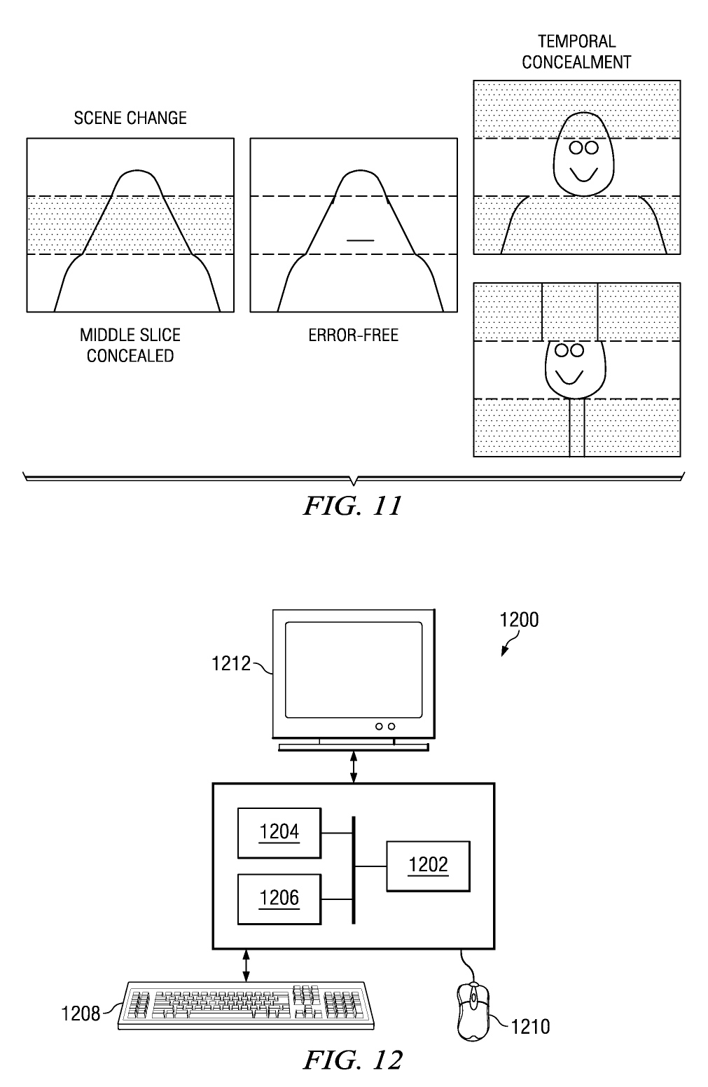

Scene change detection is required to effectively choose between using temporal and spatial concealment. For example, if spatial concealment is performed for periodic I-frames, quality may degrade. Conversely, if temporal concealment is performed for a scene change, the result is a mix of two scenes that propagates until the next error-free I-frame is decoded. For example, consider a scene with 3 slices per frame, as shown in FIG. 11. In this example, the hash lines show the concealed slices for 3 consecutive frames. If the first frame in the scene successfully decodes the first and last slice, and conceals the middle slice, then the second frame is error-free. If the third frame is an I-frame, and successfully decodes the middle slice only, a scene change cannot be detected reliably based on the middle slice. In fact, if a scene change is detected, the top and bottom slices will be spatially concealed, which covers up the true scene data. Therefore, the prior error-free macroblocks are only reliable if they did not propagate errors from the previous scene change.

FIG. 10 is a flow diagram of a method for scene change detection when block loss occurs in accordance with one or more embodiments of the invention. In general, a metric for macroblock energy in a frame is used to determine how dissimilar an I-frame is from the previous frame, i.e., whether a scene change is to be detected. When an I-frame is decoded, the method of FIG. 10 is performed to determine if a scene change should be detected. Initially, the values for current frame energy, previous frame energy, and good macroblock count are set to zero (1000). The method then iterates through each macroblock in the I-frame to compute the number of reliable macroblocks for scene change comparison.

More specifically, a check is made to determine if there is an error in the current macroblock (1002). If there is no error, then a check is made to determine if a co-located macroblock in a previous frame is concealed, i.e., if there was an error in the co-located macroblock (1004). More specifically, the collocated macroblock in two prior frames, the previous frame and the previous I-frame (or a previous frame with a large percentage of intracoded macroblocks) is checked. If there is an error in the current macroblock or the co-located macroblock in the previous frame or the co-located macroblock in the previous I-frame, the method continues with the next macroblock in the I-frame unless the current macroblock is the last macroblock in the I-frame (1008).

If the current macroblock is error free (1002) and the co-located macroblock is not concealed in either the previous frame or the previous I-frame (1004), then the current frame energy is increased based on the energy of the current macroblock, the previous frame energy is increased based on the energy of the co-located macroblock in the previous frame, and the good macroblock count is incremented (1006). In one or more embodiments of the invention, the energy of a macroblock is the luma DC value of the macroblock (i.e., the sum of all (unsigned) luma pixels in the macroblock) and frame energy is the sum of the energies of the reliable macroblocks to be compared. The method then continues with the next macroblock in the I-frame unless the current macroblock is the last macroblock (1008). Once all macroblocks in the I-frame are processed, the current frame energy, the previous frame energy, and the good macroblock count are used to determine if a scene change is to be detected. In one or more embodiments of the invention, the absolute value of the difference between the current frame energy and the previous frame energy is computed and divided by the good macroblock count. If the result is greater than a threshold, a scene change is detected. If a scene change is detected, then spatial concealment is used for lost macroblocks in the I-frame.

Embodiments of the methods and systems for video decoding described herein may be implemented for virtually any type of digital system (e.g., a desk top computer, a laptop computer, a handheld device such as a mobile (i.e., cellular) phone, a personal digital assistant, a digital camera, etc.) with functionality to display encoded video sequences. For example, as shown in FIG. 12, a digital system (1200) includes a processor (1202), associated memory (1204), a storage device (1206), and numerous other elements and functionalities typical of today's digital systems (not shown). In one or more embodiments of the invention, a digital system may include multiple processors and/or one or more of the processors may be digital signal processors. The digital system (1200) may also include input means, such as a keyboard (1208) and a mouse (1210) (or other cursor control device), and output means, such as a monitor (1212) (or other display device). The digital system ((1200)) may also include an image capture device (not shown) that includes circuitry (e.g., optics, a sensor, readout electronics) for capturing digital images and video sequences. The digital system (1200) may be connected to a network (1214) (e.g., a local area network (LAN), a wide area network (WAN) such as the Internet, a cellular network, any other similar type of network and/or any combination thereof) via a network interface connection (not shown). Encoded video sequences may be received over the network and/or read from the storage device (1206), decoded using one or more of the error recovery techniques described herein, and displayed on the display device (1212). Those skilled in the art will appreciate that these input and output means may take other forms.

Further, those skilled in the art will appreciate that one or more elements of the aforementioned digital system (1200) may be located at a remote location and connected to the other elements over a network. Further, embodiments of the invention may be implemented on a distributed system having a plurality of nodes, where each portion of the system and software instructions may be located on a different node within the distributed system. In one embodiment of the invention, the node may be a digital system. Alternatively, the node may be a processor with associated physical memory. The node may alternatively be a processor with shared memory and/or resources.

Software instructions to perform embodiments of the invention may be stored on a computer readable medium such as a compact disc (CD), a diskette, a tape, a file, or any other computer readable storage device. The software instructions may be distributed to the digital system (800) via removable memory (e.g., floppy disk, optical disk, flash memory, USB key), via a transmission path (e.g., applet code, a browser plug-in, a downloadable standalone program, a dynamically-linked processing library, a statically-linked library, a shared library, compilable source code), etc.

While the invention has been described with respect to a limited number of embodiments, those skilled in the art, having benefit of this disclosure, will appreciate that other embodiments can be devised which do not depart from the scope of the invention as disclosed herein. For example, encoding architectures for video compression standards other than H.264 may be used in embodiments of the invention and one of ordinary skill in the art will understand that these architectures may use the error resilience techniques described herein. Accordingly, the scope of the invention should be limited only by the attached claims.

It is therefore contemplated that the appended claims will cover any such modifications of the embodiments as fall within the true scope and spirit of the invention.

What is claimed is:

1. A method for decoding an encoded video stream, the method comprising:
when a sequence parameter set in the encoded video stream is lost, wherein the sequence parameter set comprises a frame number parameter, a picture order count parameter, a picture height parameter, a picture width parameter, and a plurality of non-critical parameters,
assigning default values to the plurality of non-critical parameters;
setting the picture height parameter and the picture width parameter based on a common pixel resolution;
when a slice header of an instantaneous decoding refresh picture is available,
determining the frame number parameter from the slice header, and
determining the picture order count parameter using the frame number parameter, the default values, the pixel height parameter, and the picture width parameter; and
using the picture order count parameter, the frame number parameter, the default values, the pixel height parameter, and the picture width parameter to decode a slice in the encoded video stream.

2. The method of claim 1, wherein determining the picture order count parameter further comprises attempting to decode a slice of the encoded video stream using a trial value for the picture order count parameter, the frame number parameter, the default values, the pixel height parameter, and the picture width parameter.

3. The method of claim 1, further comprising:
when a slice header of an instantaneous decoding refresh picture is not available,
determining the frame number parameter and the picture order count parameter using the default values, the pixel height parameter, and the picture width parameter.

4. The method of claim 3, wherein determining the frame number parameter and the picture order count parameter further comprises attempting to decode a slice of the encoded video stream using a trial value for the picture order count parameter, a trial value of the frame number parameter, the default values, the pixel height parameter, and the picture width parameter.

5. The method of claim 1, further comprising:
determining frame energy of an intracoded frame, wherein the frame energy is based on the energy of each macroblock in the intracoded frame that is error-free and has a co-located macroblock in a previous frame and a previous intracoded frame that is error-free;
determining frame energy of the previous frame, wherein the frame energy is based on the energy of each macroblock in the previous frame that is error-free and has a co-located macroblock in the intracoded frame and the previous intracoded frame that is error-free; and
using the frame energy of the intracoded frame and the frame energy of the previous frame to determine if a scene change has occurred.

6. The method of claim 1, further comprising:
determining a macroblock address of an initial macroblock of a current slice;
when the macroblock address of the initial macroblock and a macroblock address of a last macroblock decoded in a previous slice are in raster order, using a macroblock-based loop filter for the current slice;
when the macroblock address of the last macroblock decoded is not greater than the macroblock address of the initial macroblock, detecting arbitrary slice order mode and using a frame-based loop filter for the current slice; and
when the macroblock address of the last macroblock decoded is greater than the macroblock address of the initial macroblock, not detecting arbitrary slice order mode and turning off loop filtering across slice boundaries.

7. The method of claim 1, further comprising:
when a type of a network abstraction layer (NAL) unit is an access unit delimiter (AUD) type and a length of the NAL unit is too long for an AUD,
determining if a start code of the next NAL unit is corrupted;
when the start code is corrupted, processing the NAL unit as an AUD; and
when the start code is not corrupted, processing the NAL unit as having a corrupted NAL unit type.

8. The method of claim 7, wherein determining if a start code is corrupted further comprises determining the start code is corrupted when a number of ones in three bytes that should contain the start code is less than a threshold.

9. The method of claim 1, further comprising:
when temporal concealment is to be used to estimate a motion vector for a lost macroblock in a frame,
when motion vectors for neighboring macroblocks below the lost macroblock in the frame are available, estimating the motion vector using motion vectors from up to three neighboring macroblocks above and below the lost macroblock in the frame, wherein the three neighboring macroblocks have a same reference frame; and
when motion vectors for neighboring macroblocks below the lost macroblock in the frame are not available, estimating the motion vector using a motion vector for a co-located macroblock in a previous reference frame, a motion vector for a macroblock immediately above the lost macroblock in the frame, and a motion vector for a macroblock immediately above and to the right of the lost macroblock in the frame.

10. The method of claim 1, further comprising:
when there is horizontal motion in a global motion vector of a frame, an edge macroblock on a side of the frame where new content is coming in is lost, and there are no errors in a macroblock immediately above the edge macroblock in the frame and a macroblock immediately below the edge macroblock in the frame, using spatial concealment for the lost edge macroblock with no smoothing.

11. A video decoder for decoding an encoded video stream, wherein decoding an encoded video stream comprises:
when a sequence parameter set in the encoded video stream is lost, wherein the sequence parameter set comprises a frame number parameter, a picture order count parameter, a picture height parameter, a picture width parameter, and a plurality of non-critical parameters,
assigning default values to the plurality of non-critical parameters;
setting the picture height parameter and the picture width parameter based on a common pixel resolution;
when a slice header of an instantaneous decoding refresh picture is available,
determining the frame number parameter from the slice header, and
determining the picture order count parameter using the frame number parameter, the default values, the pixel height parameter, and the picture width parameter; and
using the picture order count parameter, the frame number parameter, the default values, the pixel height parameter, and the picture width parameter to decode a slice in the encoded video stream.

12. The decoder of claim 11, wherein decoding an encoded video stream further comprises:
when a slice header of an instantaneous decoding refresh picture is not available,
determining the frame number parameter and the picture order count parameter using the default values, the pixel height parameter, and the picture width parameter.

13. The decoder of claim 11, wherein decoding an encoded video stream further comprises:
determining frame energy of an intracoded frame, wherein the frame energy is based on the energy of each macroblock in the intracoded frame that is error-free and has a co-located macroblock in a previous frame and a previous intracoded frame that is error-free;
determining frame energy of the previous frame, wherein the frame energy is based on the energy of each macroblock in the previous frame that is error-free and has a co-located macroblock in the intracoded frame and the previous intracoded frame that is error-free; and
using the frame energy of the intracoded frame and the frame energy of the previous frame to determine if a scene change has occurred.

14. The decoder of claim 11, wherein decoding an encoded video stream further comprises:
determining a macroblock address of an initial macroblock of a current slice;
when the macroblock address of the initial macroblock and a macroblock address of a last macroblock decoded in a previous slice are in raster order, using a macroblock-based loop filter for the current slice;
when the macroblock address of the last macroblock decoded is not greater than the macroblock address of the initial macroblock, detecting arbitrary slice order mode and using a frame-based loop filter for the current slice; and
when the macroblock address of the last macroblock decoded is greater than the macroblock address of the initial macroblock, not detecting arbitrary slice order mode and turning off loop filtering across slice boundaries.

15. The decoder of claim 11, wherein decoding an encoded video stream further comprises:
when a type of a network abstraction layer (NAL) unit is an access unit delimiter (AUD) type and a length of the NAL unit is too long for an AUD,
determining if a start code of the next NAL unit is corrupted;
when the start code is corrupted, processing the NAL unit as an AUD; and
when the start code is not corrupted, processing the NAL unit as having a corrupted NAL unit type.

16. The decoder of claim 11, wherein decoding an encoded video stream further comprises:
when temporal concealment is to be used to estimate a motion vector for a lost macroblock in a frame,
when motion vectors for neighboring macroblocks below the lost macroblock in the frame are available, estimating the motion vector using motion vectors from up to three neighboring macroblocks above and below the lost macroblock in the frame, wherein the three neighboring macroblocks have a same reference frame; and
when motion vectors for neighboring macroblocks below the lost macroblock in the frame are not available, estimating the motion vector using a motion vector for a co-located macroblock in a previous reference frame, a motion vector for a macroblock immediately above the lost macroblock in the frame, and a motion vector for a macroblock immediately above and to the right of the lost macroblock in the frame.

17. The decoder of claim 11, wherein decoding an encoded video stream further comprises:
when there is horizontal motion in a global motion vector of a frame, an edge macroblock on a side of the frame where new content is coming in is lost, and there are no errors in a macroblock immediately above the edge macroblock in the frame and a macroblock immediately below the edge macroblock in the frame, using spatial concealment for the lost edge macroblock with no smoothing.

18. A digital system comprising:
a processor;
a memory; and
a video decoder configured to decode an encoded video stream by:
when a sequence parameter set in the encoded video stream is lost, wherein the sequence parameter set comprises a frame number parameter, a picture order count parameter, a picture height parameter, a picture width parameter, and a plurality of non-critical parameters,
assigning default values to the plurality of non-critical parameters;
setting the picture height parameter and the picture width parameter based on a common pixel resolution;
when a slice header of an instantaneous decoding refresh picture is available,
determining the frame number parameter from the slice header, and
determining the picture order count parameter using the frame number parameter, the default values, the pixel height parameter, and the picture width parameter;
when a slice header of an instantaneous decoding refresh picture is not available,
determining the frame number parameter and the picture order count parameter using the default values, the pixel height parameter, and the picture width parameter; and
using the picture order count parameter, the frame number parameter, the default values, the pixel height parameter, and the picture width parameter to decode a slice in the encoded video stream.

19. The digital system of claim 18, wherein the video decoder is further configured to decode an encoded video stream by:
determining frame energy of an intracoded frame, wherein the frame energy is based on the energy of each macroblock in the intracoded frame that is error-free and has a co-located macroblock in a previous frame and a previous intracoded frame that is error-free;
determining frame energy of the previous frame, wherein the frame energy is based on the energy of each macroblock in the previous frame that is error-free and has a co-located macroblock in the intracoded frame and the previous intracoded frame that is error-free; and
using the frame energy of the intracoded frame and the frame energy of the previous frame to determine if a scene change has occurred.

20. The digital system of claim 18, wherein the video decoder is further configured to decode an encoded video stream by:
when temporal concealment is to be used to estimate a motion vector for a lost macroblock in a frame,
when motion vectors for neighboring macroblocks below the lost macroblock in the frame are available, estimating the motion vector using motion vectors from up to three neighboring macroblocks above and below the lost macroblock in the frame, wherein the three neighboring macroblocks have a same reference frame; and
when motion vectors for neighboring macroblocks below the lost macroblock in the frame are not available, estimating the motion vector using a motion vector for a co-located macroblock in a previous reference frame, a motion vector for a macroblock immediately above the lost macroblock in the frame, and a motion vector for a macroblock immediately above and to the right of the lost macroblock in the frame.
